(19) United States
(12) Patent Application Publication
(10) Pub. No.: US 2009/0090492 A1
(43) Pub. Date: Apr. 9, 2009

(54) VALVE DEVICE FOR CONTROLLING A RECYCLED, GASEOUS FLUID, HEAT EXCHANGER, METHOD FOR CONTROLLING A VALVE DEVICE AND/OR FOR CONTROLLING A HEAT EXCHANGER

(75) Inventors: Frederic Ablitzer, Valdoie (FR); Jurgen Barwig, Stuttgart-Vaihingen (DE); Tobias Fetzer, Ostfildern (DE); Ulrich Maucher, Korntal-Munchingen (DE); Jens Ruckwied, Stuttgart (DE)

Correspondence Address: FOLEY AND LARDNER LLP;SUITE 500, 3000 K STREET NW, WASHINGTON, DC, 20007, US

(73) Assignee: BEHR GmbH & CO. KG

(21) Appl. No.: 12/246,919

(22) Filed: Oct. 7, 2008

(30) Foreign Application Priority Data
Oct. 8, 2007 (DE) 10 2007 048 297.5

(51) Int. Cl. F28F 7/00; F16K 11/14

(52) U.S. Cl. 165/138; 137/862

(57) ABSTRACT

A valve device for controlling a recycled, gaseous fluid and/or for heat exchanger/bypass control for a heat exchanger of an internal combustion engine of a motor vehicle, with at least one valve body, and with at least one valve housing for receiving at least part of the valve body. The valve housing has at least one inlet opening for the inflow of a gaseous fluid, at least one first outlet opening for supplying a heat exchanger with gaseous fluid, and at least one second outlet opening for causing the gaseous fluid to bypass the heat exchanger. The valve body has at least one first valve-body partial element which is in the manner of a hollow body and is intended for controlling the flow rate through at least one outlet opening, and at least one second valve-body partial element which is at least partially of conical design and is intended for controlling the flow rate through the inlet opening.

### CROSS-REFERENCE TO RELATED PATENT APPLICATIONS

The right of foreign priority is claimed under 35 U.S.C. § 119(a) based on Federal Republic of Germany Application No. 10 2007 048 297.5, filed Oct. 8, 2007, the entire contents of which, including the specification, drawings, claims and abstract, are incorporated herein by reference.

### BACKGROUND

The invention relates to a valve device for controlling a recycled, gaseous fluid and/or for heat exchanger/bypass control for a heat exchanger of an internal combustion engine of a motor vehicle, with at least one valve body, at least one valve housing for receiving at least part of the valve body, wherein the valve housing has at least one inlet opening for the inflow of a gaseous fluid, at least one first outlet opening for supplying a heat exchanger with the gaseous fluid, and at least one second outlet opening for causing the gaseous fluid to bypass the heat exchanger.

Furthermore, the present invention relates to a heat exchanger, in particular exhaust gas cooler and/or charge air cooler, with first flow ducts for guiding the gaseous fluid, and second flow ducts for guiding a second fluid for cooling the gaseous fluid, and at least one heat exchanger housing for accommodating the first flow ducts and the second flow ducts.

Furthermore, the invention relates to a method for controlling a valve device according to one of claims 1 to 15 and/or for controlling a heat exchanger according to one of claims 16 to 19.

A heat exchanger valve is known from DE 10 2006 033 585 A1. In this case, the heat-exchanger valve device has a housing and a valve actuator. Furthermore, a closing body made of a metal and/or of a sintered material, such as, for example, ceramic or magnesium, or of aluminum or steel, such as, for example, high-grade steel, is provided. In order for the valve to be of leak proof design, those regions of the valve actuator and those corresponding counter surfaces of the housing in which the valve actuator slides have to be machined with great precision such that as little gas as possible, in particular exhaust gas or charge air, can flow through the remaining slot between the housing and valve actuator. Furthermore, because of the tight fit between the valve actuator and housing, the valve actuator may tilt or become jammed.

### SUMMARY OF PREFERRED EMBODIMENTS

It is in particular the object of the present invention to improve a valve device of the type described at the beginning, in particular to improve the tightness of the valve device and to avoid the risk of the valve body tilting or becoming jammed in the valve housing.

The object is achieved by the features of claim 1.

A valve device is proposed for controlling a recycled, gaseous fluid and/or for heat exchanger/bypass control for a heat exchanger of an internal combustion engine of a motor vehicle.

The valve device has at least one valve body, at least one valve housing for receiving at least part of the valve body, wherein the valve housing has at least one inlet opening for the inflow of a gaseous fluid, at least one first outlet opening for supplying a heat exchanger with the gaseous fluid, and at least one second outlet opening for causing the gaseous fluid to bypass the heat exchanger. The valve body has at least one first valve-body partial element which is in the manner of a hollow body and is intended for controlling the flow rate through at least one outlet opening, and at least one second valve-body partial element which is of at least partially conical design, in particular in the manner of a plate, for controlling the flow rate through the inlet opening.

In an advantageous development, it is provided that the first valve-body partial element controls the flow rate through the first outlet opening and/or through the second outlet opening. It is thereby particularly advantageously possible for the flow rate for two outlet openings to be controlled by means of one valve-body partial element.

In an advantageous development of the invention, the first valve-body partial element and the second valve-body partial element are designed as a single part. It is thereby particularly advantageously possible for additional installation or joining devices to be saved.

In an advantageous development of the invention, at least one outlet opening, in particular the at least one first outlet opening and/or the at least one second outlet opening, and/or the at least one inlet opening is/are of slot-shaped design. It is thereby particularly advantageously possible for pressure losses as the gaseous fluid flows through the outlet opening or the inlet opening to be reduced without having to reduce the flow rate.

In an advantageous development of the invention, the first valve-body partial element is of cylindrical design at least in some regions. At least one first cross-sectional area has a first diameter. The first valve-body partial element thereby has a surface which can be produced in a particularly advantageous manner and is intended for bearing against the valve housing.

In a further advantageous development of the invention, the second valve-body partial element is designed in the manner of a truncated cone, in particular is designed in the shape of a plate. The inlet opening of the valve device can thereby be particularly advantageously tightly closed such that no gaseous fluid can enter the valve housing via the inlet opening.

In an advantageous development of the invention, the second valve-body partial element has at least one second cross-sectional area with a second diameter. The inlet opening of the valve device can thereby be particularly advantageously closed by means of the second valve-body partial element.

In an advantageous development of the invention, the at least one first diameter is larger than the at least one second diameter. It is thereby particularly advantageously possible for the diameter of the first valve-body partial element to be designed to be larger than the second valve-body partial element. As a result, pressure losses during the flow from the inlet opening to the at least one, in particular, the two, outlet openings can be particularly advantageously avoided.

In a particularly advantageous development, a diameter ratio of the first diameter to the second diameter is 3:1, in particular 2:1, in particular 1.5:1.

In a particularly advantageous development of the invention, the first valve body has at least one through opening through which the gaseous fluid flows. A separation of functions with, firstly, a particularly tight sealing of the inlet opening and, secondly, reliable operation of the valve device without becoming jammed and tilting can thereby be particularly advantageously ensured.

In an advantageous development of the invention, the at least one through opening is at least partially designed in the manner of a cylindrical segment. The first valve-body partial element can thereby be of particularly lightweight and nevertheless stable design by in particular adjacent through openings being separated by means of a separating web.

In an advantageous development of the invention, the at least one inlet opening is of conical design and/or is designed as a second valve seat surface for the second valve-body partial element to bear against. The inlet opening can thereby be sealed particularly advantageously with the second valve-body partial element.

In a particularly advantageous development of the invention, the valve housing is designed in the manner of a cage. This makes it particularly advantageously possible to save on material and to reduce the weight and nevertheless to ensure that the valve housing is capable of functioning.

In a particularly advantageous development of the invention, the valve housing has a cavity which is designed in the manner of a cylinder, with a valve-housing inner cross-sectional area which substantially has the first diameter. The first valve-body partial element can thereby be received particularly advantageously by means of the cavity designed in the manner of a cylinder, and the first valve-body partial element can be particularly advantageously guided in this manner.

In a particularly advantageous development of the invention, the first valve-body partial element is arranged in an axially displaceable manner in the cavity of the valve housing. It is thereby possible for the two outlet openings and the inlet opening to be opened or closed in accordance with the particular requirements.

Furthermore, a heat exchanger, in particular an exhaust gas cooler and/or a charge air cooler, is provided according to the invention, the heat exchanger having first flow ducts for guiding the gaseous fluid and second flow ducts for guiding a second fluid for cooling the gaseous fluid. Furthermore, the heat exchanger has at least one heat exchanger housing for accommodating the first flow ducts and the second flow ducts. At least one valve device according to one of claims 1 to 15 is arranged in the heat exchanger. In accordance with the particular requirement, the heat exchanger can therefore be supplied with gaseous fluid or the gaseous fluid can be directed around the heat exchanger.

In an advantageous development of the invention, the valve device can be fitted into the heat exchanger in the manner of a cartridge or is fitted into the heat exchanger in the manner of a cartridge or may be fitted into the heat exchanger in the manner of a cartridge. The valve device can thereby be inserted or fitted in to the heat exchanger in a particularly simple manner.

In an advantageous development of the invention, the valve housing and the heat exchanger housing are at least partially sealed in relation to each other by means of at least one seal. This particularly advantageously prevents gaseous medium and/or cooling medium from being able to inadvertently escape.

In a particularly advantageous development, the valve housing and the heat exchanger housing are designed as a single part. This makes it particularly advantageously possible to save on additional installation steps for installing the valve housing in the heat exchanger housing.

According to the invention, a method for controlling a valve device according to one of claims 1 to 15 and/or for controlling a heat exchanger according to one of claims 16 to 19 is furthermore provided. The valve body takes up a first end position in which the second valve-body partial element closes the inlet opening and the first valve-body partial element opens up the first outlet opening and closes the second outlet opening.

In an advantageous development of the invention, the valve body takes up a second position in which the second valve-body partial element opens up the inlet opening. The first valve-body partial element opens up the first outlet opening and closes the second outlet opening. The first outlet opening, in particular the heat exchanger, is thereby supplied with gaseous fluid.

In an advantageous development of the invention, the valve body takes up a third position in which the second valve-body partial element opens up the inlet opening. The first valve-body partial element closes the first outlet opening and the second outlet opening.

In an advantageous development of the invention, the valve body takes up a fourth position in which the second valve-body partial element opens up the inlet opening. The first valve-body partial element closes the first outlet opening and opens up the second outlet opening in order to supply the second outlet opening, in particular the bypass, with gaseous fluid through the through opening. Gaseous fluid, in particular exhaust gas and/or charge air, is thereby particularly advantageously guided around the heat exchanger without having been cooled.

Further advantageous refinements of the invention emerge from the dependent claims and from the drawing. The dependent claims relate to the valve device according to the invention and to the heat exchanger according to the invention and to the method according to the invention for controlling the valve device and/or the heat exchanger.

Further objects, features and advantages of the present invention will become apparent from the detailed description of preferred embodiments that follows, when considered together with the accompanying figures of drawing.

### BRIEF DESCRIPTION OF THE DRAWINGS

FIG. 1 shows a sectional illustration of the valve device,

FIG. 2a shows a first isometric illustration of the valve housing;

FIG. 2b shows a second isometric illustration of the valve housing;

FIG. 2c shows a sectional illustration of the valve housing;

FIG. 3a shows a first isometric illustration of the first valve-body partial element;

FIG. 3b shows a second isometric illustration of the first valve-body partial element;

FIG. 3c shows a front view of the first valve-body partial element;

FIG. 3d shows a sectional illustration of the first valve-body partial element;

FIG. 4 shows a control diagram of the valve device, with the mass flow being plotted over the stroke;

FIG. 5a shows a first position of the valve device;

FIG. 5b shows a second position of the valve device;

FIG. 5c shows a third position of the valve device;

FIG. 5d shows a fourth position of the valve device;

FIG. 6a shows a first isometric illustration of the heat exchanger with the valve device;

FIG. 6b shows a sectional illustration of the heat exchanger with the valve device;

FIG. 6c shows a second isometric illustration of the heat exchanger with the valve device.

### DETAILED DESCRIPTION OF THE PREFERRED EMBODIMENTS

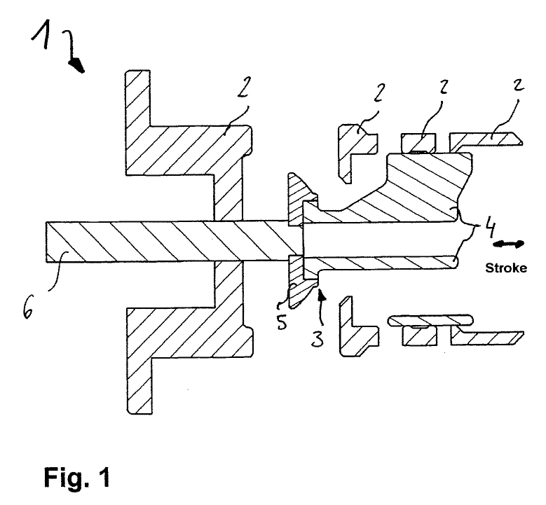

FIG. 1 shows a sectional illustration of the valve device 1.

The valve device 1 has a valve housing 2 and a valve body 3. The valve body 3 has a first valve-body partial element 4 and second valve body element 5. A rod 6 is inserted into a bore (not denoted specifically) of the second valve body element 5 and is connected to the latter, for example via a form-fitting connection, such as a thread, or via a frictional connection, such as, for example, an interference fit. The second valve-body partial element 5 is designed in the manner of a truncated cone, in particular as a plate element. The plate-like second valve-body partial element 5 has a substantially cylindrical cutout. The first valve-body partial element 4 has a collar (not denoted specifically) which is designed as a corresponding counter part to the cutout in the second valve-body partial element 5. The second valve-body partial element 5 and the first valve-body partial element 4 can thereby be connected to each other by means of a form-fitting connection, for example by a thread, and/or by means of a frictional connection, such as, for example, by an interference fit. In the exemplary embodiment illustrated, the collar (not denoted specifically) of the first valve-body partial element 4 is arranged adjacent to the rod 6.

The individual details of the valve housing 2 and of the valve body 3 and also of the first valve-body partial element 4 and of the second valve-body partial element 5 are described in more detail in the following figures.

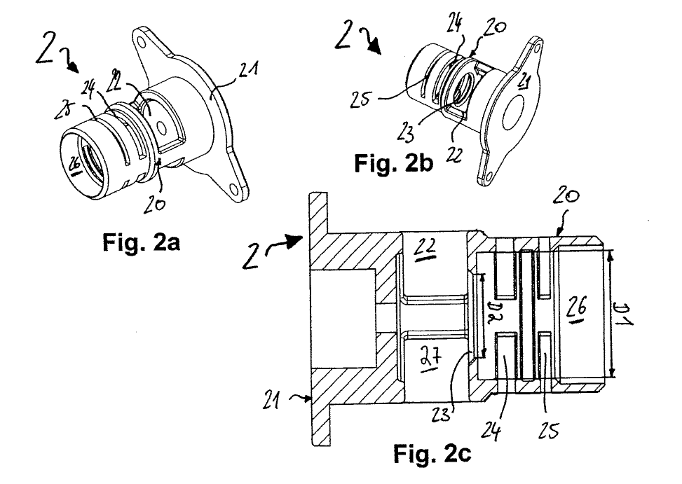

FIG. 2a shows a first isometric illustration of the valve housing 2.

FIG. 2b shows a second isometric illustration of the valve housing 2, and FIG. 2c shows a sectional illustration of the valve housing 2. Identical features are provided with the same reference numbers as in FIG. 1.

The valve housing 2 has a first housing element 20 and a second housing element 21. The first housing element 20 and the second housing element 21 can be connected to each other or designed as a single part. The valve housing 2 can be formed from steel, such as, for example, high-grade steel, or from aluminum or from a different metallic material. Furthermore, the valve housing 2 can be formed from ceramic. Furthermore, the valve housing 2 can also be formed from a fiber composite material. The valve housing 2 can also be formed from a plastic having high-temperature stability.

The second housing element 21 is designed as a flange. The flange is designed substantially as an annular element with a central bore. In the exemplary embodiment illustrated, two tongue elements extend from the annular element. Each tongue element has a bore which, for example, can have a thread. The bore can receive, for example, fastening elements, such as screws. In another exemplary embodiment, only one such tongue element or more than two tongue elements is or are provided.

The first housing element is designed as a cylindrical body. The cylindrical body is designed as a hollow body and has at least one cavity 26. The first housing element 20 has one or more cylinder sections. In the exemplary embodiment illustrated, the first housing element 20 has a first cylinder section (not denoted specifically) and a further, second cylinder section (not denoted specifically). At least one first inlet opening 22 is provided in the region of the second cylinder section (not denoted specifically) which has a larger outside diameter. The first inlet opening 22 is in particular of slot-like design. In this manner, gaseous fluid, such as, for example, exhaust gas and/or charge air, can flow in to the second housing element 21. In the exemplary embodiment illustrated, the housing 2 has two first inlet openings 22 which are arranged such that they are substantially opposite each other. The two first inlet openings 22 are separated from each other by two webs (not denoted specifically). In another exemplary embodiment (not illustrated), just one or more than two first inlet openings 22 can be provided on the circumference of the larger cylinder section of the first housing element.

A first bore (not denoted specifically) for the passage of the rod 6 is arranged substantially centrally in the valve housing 2. Furthermore, a second inlet opening 23 is arranged centrally. The second inlet opening 23 is of at least partially conical design, for example in the form of a depression, and with a further section of cylindrical design. The second inlet opening 23 can also be designed entirely as a conical bore or entirely as a cylindrical bore. The second inlet opening 23 serves to receive the second valve-body partial element 5, in particular the plate element. It is designed as a valve seat in such a manner that, when the second valve-body partial element 5 bears against it, the cavity 26 is separated in a sealed manner from the second cavity 27. This prevents gaseous fluid, such as exhaust gas and/or charge air, from being able to flow in to the first cavity 26 and through the first outlet opening 24 and/or the second outlet opening 25 when the second valve-body partial element 5 bears against the second inlet opening 23. The first cavity 26 is arranged in the region of the first housing element 20 having the smaller cylinder diameter. In comparison to the cylinder section on which the first inlet openings 22 are arranged, at least one first outlet opening 24 and at least one first second outlet opening 25 are provided on the cylinder wall of the cylinder having the smaller diameter. In the exemplary embodiment illustrated, the first outlet opening 24 is slot-shaped. The second outlet opening 25 is likewise slot-shaped. In the exemplary embodiment illustrated, the slot height (not denoted specifically) of the first outlet opening 24 is greater than the slot height of the second outlet opening 25. In another exemplary embodiment (not illustrated), the first outlet opening 24 and the second outlet opening 25 have substantially the same slot height. In another exemplary embodiment (not illustrated), the slot height of the first outlet opening 24 is smaller than the slot opening of the second outlet opening 25.

In the exemplary embodiment illustrated, two first slot-shaped outlet openings are arranged in the cylinder wall (not denoted specifically). The first slot-shaped outlet openings 24 are arranged substantially opposite each other and are separated from each other by two separating webs. In another exemplary embodiment (not illustrated), it is possible for only one outlet opening 24 to be provided or for more than two first outlet openings 24 to be provided.

In the exemplary embodiment illustrated, two second outlet openings 25 are arranged opposite each other and are separated from each other by two separating webs (not denoted specifically). In another exemplary embodiment which is not illustrated specifically, it is possible for just one second outlet opening 25 to be provided in the second valve housing or for more than two second outlet openings 25 to be provided in the valve housing 2.

The second inlet opening 23 has a diameter D2. The first cavity 26 has at least one cylinder section, in particular a number of cylinder sections, with a diameter D1. The diameter D1 substantially corresponds to the outside diameter of the valve body 3. Said cylinder sections having the diameter D1 serve as a guide surface for the valve body 3. The diameter D1 is larger than the diameter D2. In particular, a diameter ratio of the first diameter D1 to the second diameter D2 is 3:1, in particular 2:1, in particular 1.5:1. Owing to the fact that the diameter of the bore of the cavity 26 is larger than the opening diameter D2 of the second valve-body partial element, a pressure loss which is small arises on account of the long encircling outlet openings 24 and 25 for supplying the heat exchanger, in particular exhaust gas and/or charge air cooler, or the bypass. A sufficient cross-sectional area is thereby available even if the gap width is small. Only small pressure losses arise since a large passage cross section is provided for a small stroke of the valve body 2. The first outlet openings 24 and the second outlet openings 25 are designed in such a manner that the two outlet openings 24 and 25 are covered and/or opened up successively, and/or only one outlet opening is covered or opened up, by means of the valve stroke.

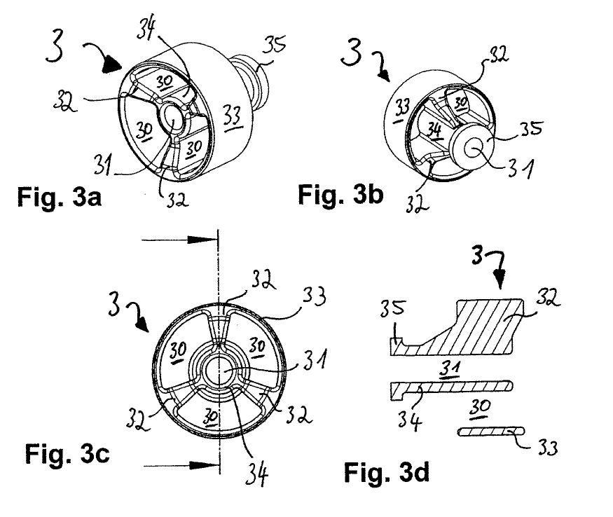

FIG. 3a shows a first isometric illustration of the first valve-body partial element 4.

FIG. 3b shows a second isometric illustration of the first valve-body partial element 4.

FIG. 3c shows a front view of the first valve-body partial element 4.

FIG. 3d shows a sectional illustration of the first valve-body partial element 4. Identical features are provided with the same reference numbers as in the previous figures.

FIGS. 3a, 3b, 3c and 3d illustrate the valve body 3 without the second valve-body partial element. The valve body 3 is formed from a metallic material, such as, for example, aluminum, or steel, such as, for example, high-grade steel. Furthermore, the valve body 3 can be formed from a different material. In another exemplary embodiment, the valve body 3 can be formed from a ceramic material. In another exemplary embodiment, the valve body 3 is formed from a fiber composite material or from a plastic having high-temperature stability.

The valve body 3 has a first valve body cylinder 33 and a second valve body cylinder 34. The first valve body cylinder 33 is designed in particular as a cylindrical ring segment. In the exemplary embodiment illustrated, the second valve body cylinder 34 is also designed as a cylindrical ring segment. The second valve body cylinder 34 is arranged in particular coaxially in the first valve body cylinder 33. In the exemplary embodiment illustrated, three webs 32 extend from the second valve body cylinder 34 to the first valve body cylinder 33. The first valve body cylinder 33 and the second valve body cylinder 34 are thereby connected to each other. In the exemplary embodiment illustrated, the first valve body cylinder 33, the second valve body cylinder 34 and the three webs 32 are formed as a single part. A collar 35 is arranged at one end of the second valve body cylinder 34. The collar 35 is substantially designed as a cylindrical disk element, with a diameter (not denoted specifically) of the collar 35 being larger than the largest diameter of the second valve body cylinder 34. However, in another exemplary embodiment, the second valve body cylinder 34 and the collar 35 can also have substantially the same diameter. The collar 35 serves in particular to receive the second valve-body partial element 5, in particular the plate element. The first valve body cylinder 33 is shorter than the second valve body cylinder 34. In particular, the first valve body cylinder 33 is arranged offset in an axial direction of the cylinder axis with respect to the second valve body cylinder 34. The three webs 32 are designed in such a manner that they gradually form a curvature-favorable transition from the first valve body cylinder 33 to the second valve body cylinder 34 in the axial direction. In the exemplary embodiment illustrated, the three webs 32 are each arranged offset with respect to each other by 120°. In another exemplary embodiment, adjacent webs 32 can be arranged with respect to one another at an angle of 10° to 180°, in particular 20° to 170°. In another exemplary embodiment (not illustrated), the valve body 3 has just one web 32 or two webs 32, which are arranged in particular opposite each other, or more than three webs.

The second valve body cylinder 34 has a valve body opening 31, in particular for receiving some regions of the rod 6. Furthermore, at least one through opening 30, in the exemplary embodiment illustrated three through openings 30, is/are formed between the webs 32. In particular, a through duct 30 is designed in the manner of a cylindrical segment. Gaseous fluid, such as, for example, exhaust gas and/or charge air, can flow through the through duct or the through opening 30. The through duct or the through opening 30 is bounded by a wall section (not denoted specifically) of the second valve body 34, a wall section (not denoted specifically) of the first valve body cylinder 33 and by the two wall sections (not denoted specifically) of two webs 32.

The first valve-body partial element and the second valve-body partial element can be formed, for example, as a single part. The second valve-body partial element 5 is designed in such a manner that, in the closed state, leakages are minimal or are minimized. By means of an axial stroke in the direction of the rod 6 or of the cylinder axes, the second valve-body partial element 5 which is designed in the manner of a plate is placed tightly in a substantially encircling manner against the bearing seat, in particular the second inlet opening 23.

The sealing of the first valve body cylinder 33 of the valve body 3 with respect to the two outlet openings 24 and 25 requires less exacting measures with regard to the tightness. There can be a certain difference between the outside diameter of the first valve body cylinder 33 and the diameter D1. This difference ensures that, if the valve housing or the valve body 3 is deformed or distorted, the valve body does not become wedged in the valve housing. Small leakages in these regions are therefore negligible, since small leakages of fluid to be cooled, such as, for example, exhaust gas and/or charge air, lead only to an insignificant cooling of the bypass or only to a small degree of heating of the cooled exhaust gas and/or of the charge air.

The second valve-body partial element 5 and the rod 6 can take place in a clamping means, for example by means of welding, in particular laser welding. Furthermore, these two elements can also be joined frictionally and/or in a form-fitting manner in a different way. In another embodiment, the two parts are designed as a single part.

The rod 6, the first valve-body partial element 4 and the second valve-body partial element 5 can be joined mechanically, for example by pressing the plate-shaped second valve-body partial element 5 and the first valve-body partial element 4 onto the rod 6, in particular the shaft. The first valve-body partial element 4 can be additionally secured, for example, by means of a welding tacking mechanism or by calking. The second valve-body partial element 5, which is designed in particular in the manner of a plate, and the first valve-body partial element 4 can be connected, for example in two working steps successively, to the shaft 6, in particular the rod, in particular can be joined thereto, such as, for example, by means of two welding processes, by means of pressing-on processes or by means of welding and subsequent pressing on. The further elements of the valve body 3, such as, for example, the first valve body cylinder 33 and the second valve body cylinder 34, and/or the collar 35 can also be connected to one another by means of joining processes, such as soldering, welding or adhesive bonding, or by means of mechanical joining processes, such as, for example, pressing on. Furthermore, the corresponding parts can be produced as a single part, for example by means of casting and subsequent machining, such as, for example, turning, drilling, grinding etc.

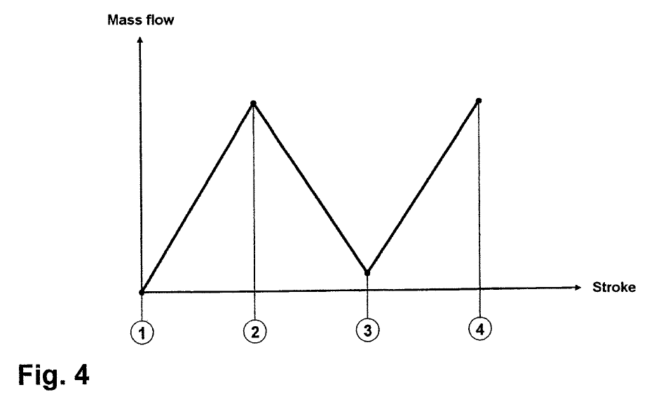

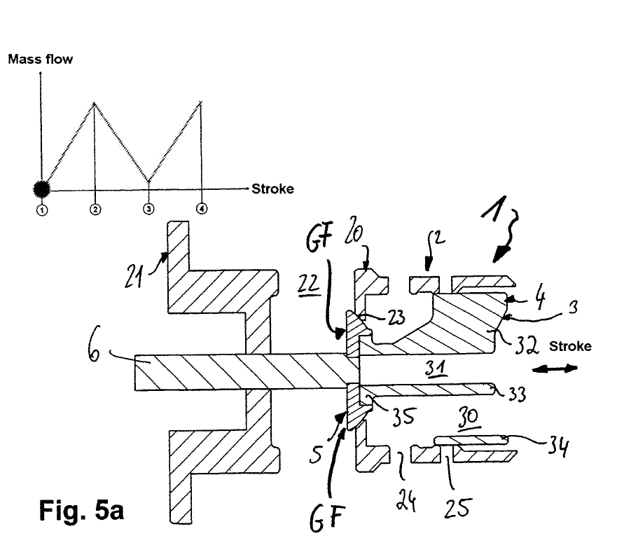

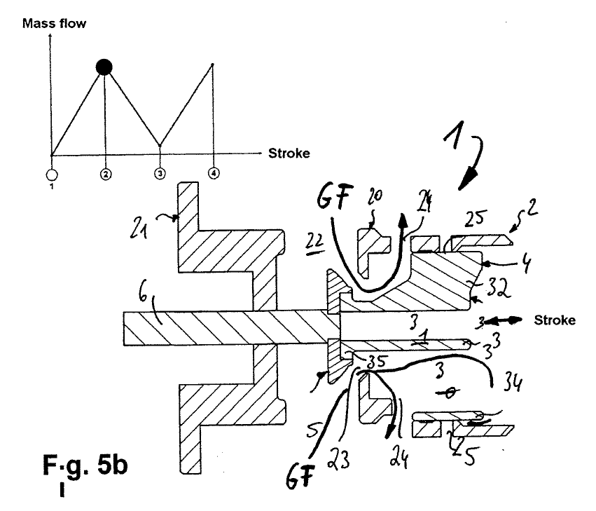

FIG. 4 shows a control diagram of the valve device 1, with the mass flow of the gaseous fluid, in particular of the exhaust gas and/or of the charge air, being plotted above the stroke of the valve body 3. The points 1, 2, 3 and 4 represent certain valve positions which are described and illustrated in more detail in the following figures.

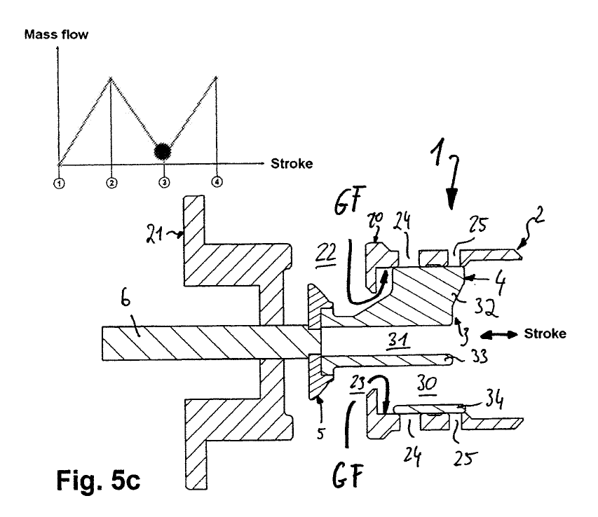

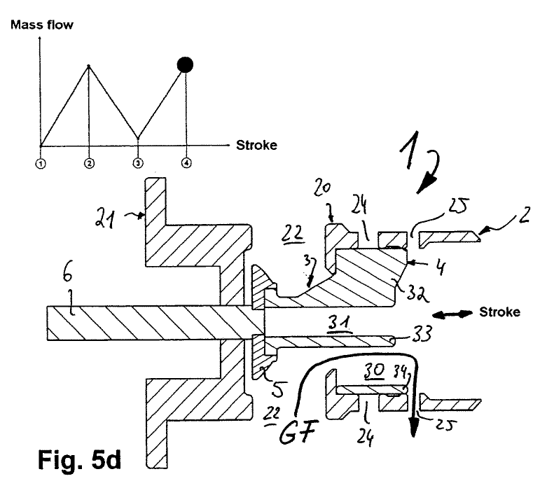

FIG. 5a shows a first valve position of the valve body 3 of the valve 1 in the valve housing 3. Identical features are provided with the same reference numbers as in the previous figures.

The second valve-body partial element 5 bears substantially flush in the inlet opening 23 in such a manner that gaseous fluid, in particular exhaust gas and/or charge air, flowing in via the first inlet openings 22 cannot flow through the second inlet opening 23.

FIG. 5b shows a second position of the valve 1 and of the valve body 3 in the valve housing 2. Identical features are provided with the same reference numbers as in the previous figures.

The second valve-body partial element 5 opens up the second inlet opening 23 in such a manner that the maximum mass flow of the gaseous fluid through the second inlet opening 23 can flow through the first outlet opening which is opened up to the maximum, in particular through the first outlet openings 24, into the heat exchanger, in particular the exhaust gas cooler and/or the charge air cooler. The second outlet opening 25, in particular the second outlet openings 25, is or are closed. However, the second outlet openings 25 are not closed completely tightly. At least a very small amount of leakage can still flow into the bypass via the at least one second outlet opening 25.

FIG. 5c shows a third position of the valve device 1 that is taken up by the valve body 3 in the valve housing 2. In this case, the second inlet opening 23 is opened up such that gaseous fluid can flow into the cavity 26 of the valve housing 2. However, the second outlet opening 24, in particular the second outlet openings 24, and the at least one first second outlet opening 25, in particular the second outlet openings 25, are closed by the first valve-body partial element 4. However, they are not completely tightly closed such that a very small mass flow of leakage can flow into the heat exchanger and/or into the bypass duct. Identical features are provided with the same reference numbers as in the previous figures.

FIG. 5d shows a fourth position of the valve device 1 that is taken up by the valve body 3 in the valve housing 2. Identical features are provided with the same reference numbers as in the previous figures.

The second inlet opening 23 is opened up such that gaseous fluid, in particular exhaust gas and/or charge air, can flow through the at least one through duct, in particular the three through ducts or through openings 30, and can flow into the bypass via the at least one second outlet opening 25, in particular the second outlet openings 25.

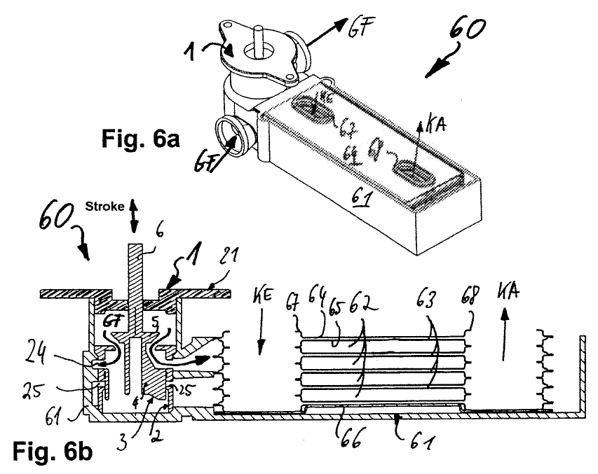

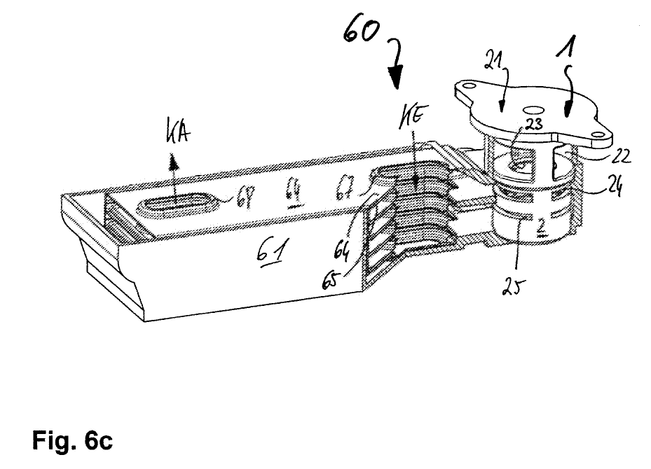

FIG. 6a shows a first isometric illustration of a heat exchanger 60 with the valve device 1.

FIG. 6b shows a sectional illustration of the heat exchanger 60 with the valve device 1, and FIG. 6c shows a second isometric illustration of the heat exchanger 60 with the valve device 1. Identical features are provided with the same reference numbers as in the preceding figures.

The heat exchanger 60 is an exhaust gas cooler. In another exemplary embodiment, the heat exchanger 60 is a charge air cooler. Furthermore, in another exemplary embodiment (not illustrated), the heat exchanger 60 can be an oil cooler, a coolant cooler or a condenser or an evaporator for an air conditioning system.

The heat exchanger 60 has a heat exchanger housing 61. The heat exchanger housing 61 serves to accommodate first flow ducts 62 and second flow ducts 63 and to accommodate first disks 64 and second disks 65. The first disks 64 and the second disks 65 are arranged in an alternating manner one above another such that a first disk 64 is arranged above a second disk 65. The first disks 64 each have a first cup 67 and a second cup 68. Similarly, the second disks 65 have a first corresponding cup 67 and a second cup 68. The first and the second disks are stacked one above another. On the one side between a first disk 64 and a second disk 65 there is a flow duct for gaseous fluid, such as, for example, exhaust gas and/or charge air, and on the other side coolant, such as, for example, cooling liquid, such as water, or water-containing cooling liquid, or air. The first cups 67 and the second cups 68 have openings for the passage of the coolant. Coolant flows into the first cups 67 via the coolant inlet KE. Coolant flows out of the second cups 68 via the coolant outlet KA.

The heat exchanger housing 61 serves to receive the valve device 1. In one exemplary embodiment, the valve housing 2 can be inserted or is inserted into the heat exchanger housing 61 in the form of a cartridge. In another embodiment, the second valve housing and the heat exchanger housing 61 are formed as a single part.

A bottom disk 66 adjoins the stack of disks comprising first disks 64 and second disks 65.

The valve housing 2 with the second inlet opening 23 is in particular part of a cage which is part of the cartridge. The cage can be extended in a manner such that the valve body 3 passes through a partial or complete stroke within the cage, in particular the housing 2. The slot-shaped first outlet openings 24 and the second outlet openings 25 form passages into the outlet ducts and are opened up or covered by the first valve body cylinder 33. In particular, the chain of tolerances of valve body 3 with respect to the sealing surface in the housing 2 is particularly advantageously shorter, since the mounting for the shaft, in particular the rod 6, and the outlet openings 24, 25 are each part of the housing 2. Narrower gaps with lower leakage can therefore be presented at the valve body 3. In a particularly advantageous manner, the valve body 3 is protected by the housing 2 from damage before and during installation. The heat exchanger housing 61 is sealed with respect to the valve housing 2, in particular the cage, in a substantially encircling manner between the exhaust gas inlet duct and the adjacent exhaust gas outlet duct. The chain of tolerances is thereby designed in such a manner that sealing takes place by means of a form-fitting connection, for example by means of a conical design of the bearing point. In the region of the first valve body cylinder 33, the sealing of the valve housing 2, in particular the cage, with respect to the heat exchanger housing 61 can take place with a loose fit, since small leakages are permissible there. In a further embodiment, a steel bushing can also be cast into the valve housing 2, with the valve housing itself being made from aluminum. This serves to increase the service life.

Furthermore, the valve housing 2 can be designed in such a manner that other functional elements, such as, for example, the bypass, a securing means for the valve drive, in particular the motor or another actuator, are arranged in the valve housing 2. Furthermore, the heat exchanger housing 61 can be designed in such a manner that other heat exchangers, such as, for example, an oil or charge air cooler, can also be accommodated. Furthermore, the heat exchanger housing 61 can have securing means for further add-on parts, or integrated ducts for guiding coolant, or other fastening elements for the fastening of sensors.

The heat exchanger 60 is in particular a U flow exhaust gas cooler. In this case, exhaust gas flows into the heat exchanger on the same side at which it leaves the heat exchanger again. Furthermore, the heat exchanger, in particular of the exhaust gas cooler, can also be designed as an I flow heat exchanger. In this case, the exhaust gas flows on one side into the heat exchanger, flows through the latter and flows out of the heat exchanger again on the other opposite side. In this case, the housing can be cooled, for example along the bypass duct.

Furthermore, the heat exchanger housing 61 can be designed as a “combination housing” such that the heat exchanger 60, in particular the exhaust gas cooler, and the valve 1 are arranged in the heat exchanger housing 61 and are accommodated by the latter.

The heat exchanger housing 61 and/or the valve housing are designed as cast housings, such as, for example, made of diecast aluminum. Furthermore, the heat exchanger housing 61 can also be formed from cast steel. Furthermore, the heat exchanger housing can also be formed from plastic or from a fiber composite material.

In the case of the design of the heat exchanger 60, in particular the exhaust gas cooler, as a U-flow heat exchanger, the housing is in particular cooled only in the region in which the valve 1 is arranged. This takes place, for example, by means of ducts in the housing 2, 61. The ducts are placed into the housing, for example, by means of bores. In particular, the ducts or parts of the ducts can already be cast in a previous working step. The openings to the outside can then be closed to the outside by means of stoppers, such as, for example, balls or the like. In the case of the design of the heat exchanger 60 as an I flow heat exchanger, in particular I flow exhaust gas cooler, the heat exchanger housing 61 and/or the valve housing 2 can remain uncooled or, in another embodiment, can be cooled in particular in the valve region. In such an embodiment, the heat exchanger housing 61 and/or the housing 2 is preferably formed from cast steel. In another embodiment of an I flow heat exchanger, in particular an exhaust gas cooler, the heat exchanger housing 61 and/or the valve housing 2 is cooled in the section in which the cooler is arranged and in particular the bypass.

The features of the different exemplary embodiments can be combined with one another as desired. The invention can also be used for fields other than those shown.

The foregoing description of preferred embodiments of the invention has been presented for purposes of illustration and description only. It is not intended to be exhaustive or to limit the invention to the precise form disclosed, and modifications and variations are possible and/or would be apparent in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto and that the claims encompass all embodiments of the invention, including the disclosed embodiments and their equivalents.

What is claimed is:

1. Valve device for controlling a recycled, gaseous fluid and/or for heat exchanger/bypass control for a heat exchanger of an internal combustion engine of a motor vehicle, having
at least one valve body,
at least one valve housing for receiving at least part of the valve body, wherein the valve housing has at least one inlet opening for the inflow of a gaseous fluid, at least one first outlet opening for supplying a heat exchanger with the gaseous fluid, and at least one second outlet opening for causing the gaseous fluid to bypass the heat exchanger,
wherein the valve body has at least one first valve-body partial element which is in the manner of a hollow body and is intended for controlling the flow rate through at least one outlet opening, and at least one second valve-body partial element which is of at least partially conical, in particular plate-like, design and is intended for controlling the flow rate through the inlet opening.

2. Valve device according to claim 1, wherein the first valve-body partial element controls the flow rate through the first outlet opening and/or through the second outlet opening.

3. Valve device according to claim 1, wherein the first valve-body partial element and the second valve-body partial element are designed as a single part.

4. Valve device according to claim 1, wherein at least one outlet opening, in particular the at least one first outlet opening and/or the at least one second outlet opening, and/or the at least one inlet opening is/are of slot-shaped design.

5. Valve device according to claim 1, wherein the first valve-body partial element is of cylindrical design at least in some regions, and/or has at least one first cross-sectional area with a first diameter.

6. Valve device according to claim 1, wherein the second valve-body partial element is designed in the manner of a truncated cone, in particular designed in the shape of a plate.

7. Valve device according to claim 1, wherein the second valve-body partial element has at least one second cross-sectional area with a second diameter.

8. Valve device according to claim 7, wherein the at least one first diameter is larger than the at least one second diameter.

9. Valve device according to claim 7, wherein a diameter ratio of the first diameter to the second diameter is 3:1, in particular 2:1, in particular 1.5:1.

10. Valve device according to claim 1, wherein the first valve-body partial element has at least one through duct through which the gaseous fluid flows.

11. Valve device according to claim 10, wherein the at least one through duct is at least partially designed in the manner of a cylindrical segment.

12. Valve device according to claim 1, wherein the at least one inlet opening is of conical design and/or is designed as a second valve seat surface for the second valve-body partial element to bear against.

13. Valve device according to claim 1, wherein the valve housing is designed in the manner of a cage.

14. Valve device according to claim 1, wherein the valve housing has a cavity which is designed in the manner of a cylinder, with a valve-housing inner cross-sectional area which essentially has the first diameter.

15. Valve device according to claim 14, wherein the first valve-body partial element is arranged in an axially displaceable manner in the cavity of the valve housing.

16. Heat exchanger, in particular exhaust gas cooler and/or charge air cooler, having
first flow ducts for guiding the gaseous fluid, and
second flow ducts for guiding a second fluid for cooling the gaseous fluid, and
at least one heat exchanger housing for accommodating the first flow ducts and the second flow ducts,
wherein at least one valve device according to claim 1 is arranged in the heat exchanger.

17. Heat exchanger according to claim 16, wherein the valve device can be fitted into the heat exchanger in the manner of a cartridge.

18. Heat exchanger according to claim 16, wherein the valve housing and the heat exchanger housing are at least partially sealed in relation to each other by means of at least one seal.

19. Heat exchanger according to one of claims 16, wherein the valve housing and the heat exchanger housing are designed as a single part.

20. Method for controlling a valve device in a heat exchanger according to claim 16, wherein the valve body takes up a first valve position in which the second valve-body partial element closes the inlet opening and the first valve-body partial element opens up the first outlet opening and closes the second outlet opening.

21. Method according to claim 20, wherein the valve body takes up a second position in which the second valve-body partial element opens up the inlet opening, the first valve-body partial element opens up the first outlet opening and closes the second outlet opening in order to supply the first outlet opening, in particular the heat exchanger, with gaseous fluid.

22. Method according to claim 20, wherein the valve body takes up a third position in which the second valve-body partial element opens up the inlet opening, and the first valve-body partial element closes the first outlet opening and the second outlet opening.

23. Method according to claim 19, wherein the valve body takes up a fourth position in which the second valve-body partial element opens up the inlet opening, the first valve-body partial element closes the first outlet opening and opens up the second outlet opening in order to supply the second outlet opening, in particular the bypass, with gaseous fluid through the through duct.
